(19) United States
(12) Patent Application Publication
(10) Pub. No.: US 2011/0241815 A1
(43) Pub. Date: Oct. 6, 2011

(54) TIGHTLY COUPLED IRON CORE SET AND WINDING RACK

(76) Inventor: Wen-Ching LU, Yilan County (TW)

(21) Appl. No.: 13/016,703

(22) Filed: Jan. 28, 2011

(30) Foreign Application Priority Data
Apr. 1, 2010 (TW) 099110026
Nov. 11, 2010 (TW) 099221835

(51) Int. Cl. H01F 27/30

(52) U.S. Cl. 336/198

(57) ABSTRACT

A tightly coupled iron core set and winding rack structure includes a winding rack and an iron core set. The winding rack includes a hollow bobbin, a first partition board and a second partition board extended radially from openings at two ends of the bobbin, and a plurality of pin sections located on the second partition board. The first and second partition boards have respectively at least one latch portion. The iron core set includes a core running through the bobbin and a plurality of latch notches coupled with the latch portions to hold the iron core set on the winding rack. Thus the iron core set can be directly latched on the winding rack to form coupling without using extra bonding or latching tools.

### FIELD OF THE INVENTION

The present invention relates to tightly coupled iron core set and winding rack and particularly to a self-fastening structure to easily couple an iron core set and a winding rack without using any auxiliary tools.

### BACKGROUND OF THE INVENTION

A conventional transformer or filter generally is formed by coupling at least one winding rack and at least one iron core to perform electromagnetic conversion to achieve its designed objective. To meet such a purpose (take the transformer as an example), the iron core and winding rack can be formed in various types to provide different functions. In order to improve electromagnetic interference (EMI), some transformers or filters adopt an EE-type iron core or EI-type iron core to encase the winding rack. For instance, R.O.C. patent No. 592377 entitled “Improved transformer structure” discloses a transformer comprising an upper iron core, a lower iron core, a plastic holder, a circuit board, a Mylar insulation film, a flat coil and a plastic insulation plate. The upper and lower iron cores have a cylinder in the center to couple the circuit board, Mylar insulation film, flat coil and plastic insulation plate in this order through a central hole formed on each of them. The plastic holder is mounted onto the lower iron core. However, the winding rack has a large area exposed outside the iron cores, hence still has room for improvement in terms of magnetic leakage and EMI.

The aforesaid conventional transformer, aside from the problem of magnetic leakage needed to be improved, the coupling of the upper and lower iron cores also creates other problem needed to be resolved. In the conventional technique, after the upper and lower iron cores have penetrated through the winding rack (or run through a plurality of windings), they are fixed to form a transformer. The simplest approach among the present techniques is to use an insulation tape to wind the upper and lower iron cores, so that the upper and lower iron cores and the winding rack (or windings) can be bonded together to form an integrated body. But the insulation tape is fragile and easily damaged during transportation or assembly. In the event that the insulation tape suffers severe damage, the transformer could be disintegrated.

An improved fixing method has been developed to reserve a plurality of grooves on the surfaces of the upper and lower iron cores and provide C-shaped iron plates. Each iron plate has an opening wedged in the grooves of the upper and lower iron cores so that multiple C-shaped iron plates can surround and hold the upper and lower iron cores. But fabricating the iron plates results in a higher cost and holding the upper and lower iron cores with the iron plates requires more manpower. Moreover, the iron plates could be loosened off during transportation.

### SUMMARY OF THE INVENTION

In view of the aforesaid conventional assembling techniques still cannot achieve a desirable balance between production yield and cost, the primary object of the present invention is to provide a coupled structure of an iron core set and a winding rack that can be assembled simply and does not loosen off easily, and also does not require extra elements to maintain the cost at a reasonable level.

The present invention provides tightly coupled iron core set and winding rack that includes a winding rack and an iron core set. The winding rack includes a hollow bobbin, a first partition board and a second partition board extended radially from openings formed at two ends of the bobbin, and a plurality of pin sections located on the second partition board. The first and second partition boards have respectively at least one latch portion. The iron core set includes a core running through the bobbin and a plurality of latch notches coupled with the latch portions to fasten the iron core set on the winding rack.

By means of the structure set forth above, the iron core set and the winding rack can be directly latched and coupled together without using extra bonding or latching tool. Coupling of the iron core set and winding rack is simpler, and can be accomplished by exerting force. Coupling requires less manpower or can be assembled mechanically and automatically to reduce cost in mass production.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a first embodiment of the invention.

FIG. 2 is another exploded view of the first embodiment of the invention.

FIG. 3A is a schematic view of a first iron core and a winding rack in a coupling condition.

FIG. 3B is a schematic view of the first iron core and the winding rack in a coupled condition.

FIG. 4A is a schematic view of a second iron core and the winding rack in a coupling condition.

FIG. 4B is a schematic view of the second iron core and the winding rack in a coupled condition.

FIG. 5 is an exploded view of a second embodiment of the invention.

FIG. 6 is an exploded view of a third embodiment of the invention.

FIG. 7 is another exploded view of the third embodiment of the invention.

FIG. 8 is a schematic view of the third embodiment with the iron core set and winding rack in a coupled condition.

FIG. 9 is a schematic view of the iron core set held by the latch portion of the winding rack.

FIG. 10 is another schematic view of the iron core set held by the latch portion of the winding rack.

### DETAILED DESCRIPTION OF THE PREFERRED EMBODIMENTS

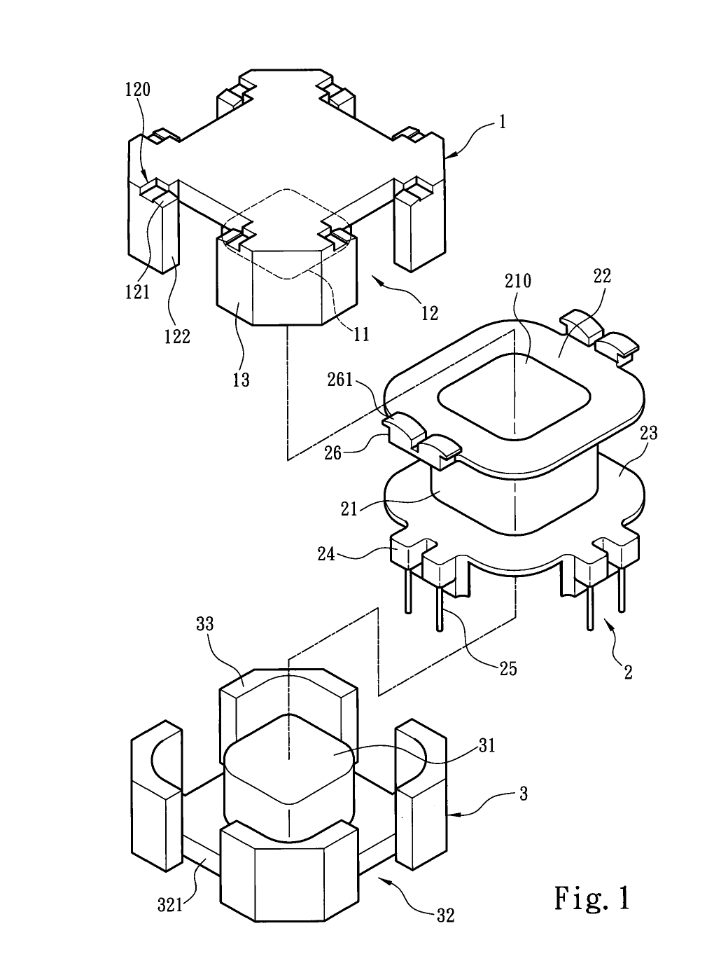

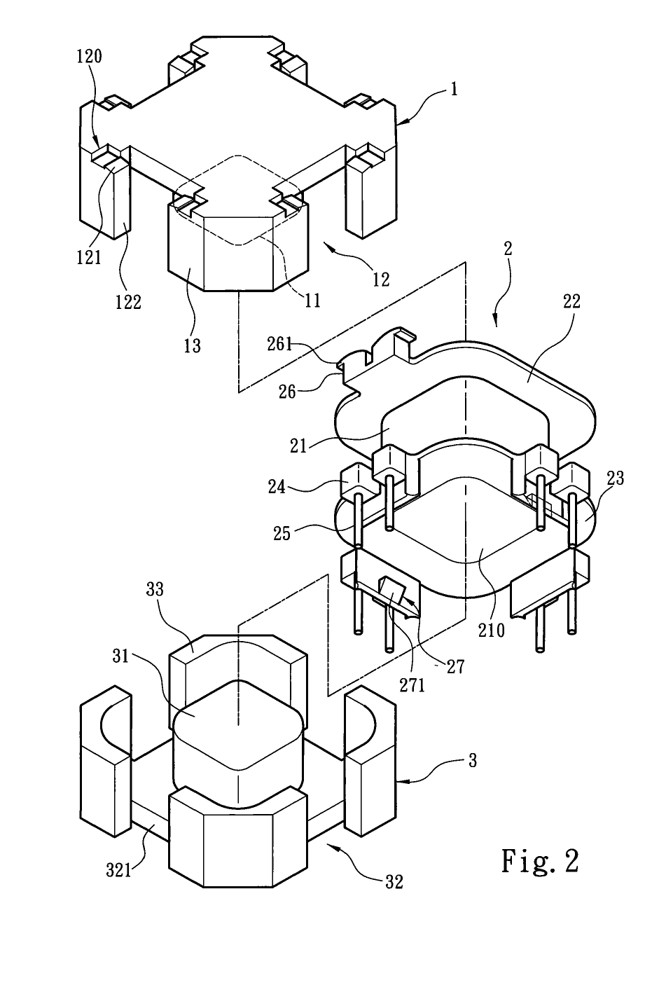

The present invention aims to provide tightly coupled iron core set and winding rack. Please refer to FIGS. 1 and 2 for a first embodiment of the invention. A winding rack 2 and an iron core set are provided. The iron core set includes a first iron core 1 and a second iron core 3. The winding rack 2 includes a hollow bobbin 21, a first partition board 22 and a second partition board 23. The bobbin 21 has two ends respectively with an opening 210. The first and second partition boards 22 and 23 are extended respectively and radially from the opening 210, and spaced from each other to form an area for winding. The second partition board 23 has a plurality of pin sections 24 connected to a plurality of conductive pins 25. A winding wound on the bobbin 21 can be electrically connected with the pins 25 through the pin sections 24. It is to be noted that while the pin sections 24 are located on the second partition board 23 in this embodiment, in practice the pin sections 24 may also be located on the first partition board 22, or on both the first and second partition boards 22 and 23. The iron core set includes a core running through the bobbin 21. In the embodiment shown in FIGS. 1 and 2, the first and second iron cores 1 and 3 have respectively a core 11 and 31 in the center at a shorter length. When the first and second iron cores 1 and 3 are coupled with the winding rack 2, the cores 11 and 31 passing through the openings 210 and running through the bobbin 21 to be connected with each other. The core of the iron core set may also be formed by only a core 11 or 31 at a greater length of the first iron core 1 or second iron core 3 (like an EI-type iron core). The type of the core 11 or 31 is not the feature of the invention, and its alternatives also are known by those skilled in the art, hence its various alterations shall be included in the scope of the invention. The first iron core 1 and second iron core 3 have respectively a plurality of isolation walls 13 and 33 that form a plurality of latch notches 12 and 32 between them. The first iron core 1, second iron core 3, and isolation walls 13 and 33 form a polygon to surround the winding rack 2 with the latch notches 12 and 32 located on the edges of the first and second iron cores 1 and 3. The latch notches 12 and 32 may be selectively formed on the longer edges of the first and second iron cores 1 and 3 to provide greater space. To couple the iron core set and the winding rack 2 through the latch notches 12 and 32 on the first and second iron cores 1 and 3, the first partition board 22 and second partition board 23 of the winding rack 2 have respectively at least one latch portion 26 and 27 that are latched with the latch notches 12 and 32 to fasten the iron core set on the winding rack 2. Through coupling of the latch portions 26 and 27 and the latch notches 12 and 32, the first and second iron cores 1 and 3 can be directly coupled with the winding rack 2 without using an insulation tape or iron plates. Thus the cost can be reduced, and assembling process of the transformer also is simpler. Moreover, the pin sections 24 and latch portions 26 and 27 can pass through the latch notches 12 and 32. The pin sections 24 and pins 25 can be extended outside the isolation walls 13 and 33 through the latch notches 12 and 32 to electrically connect with other circuit elements.

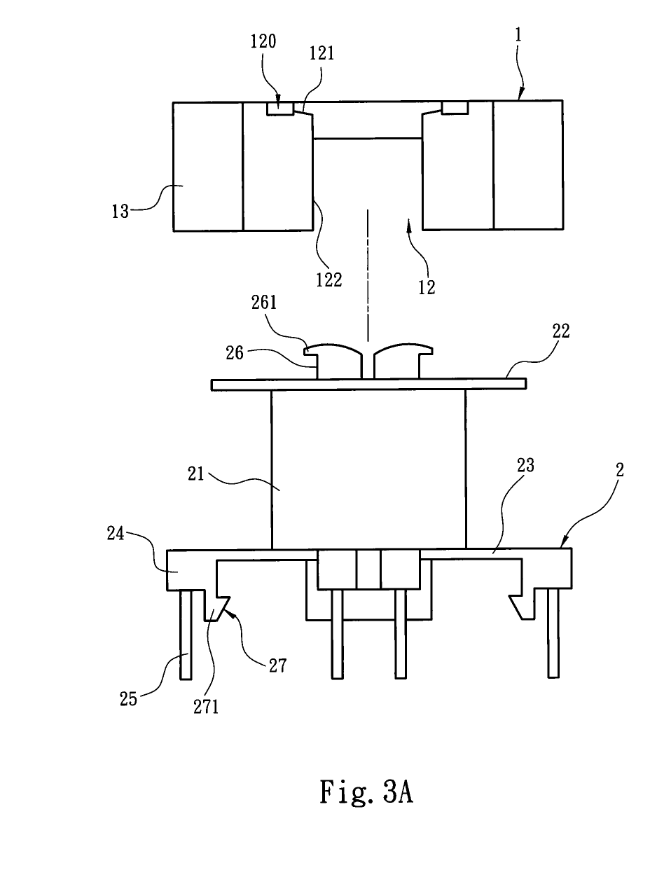

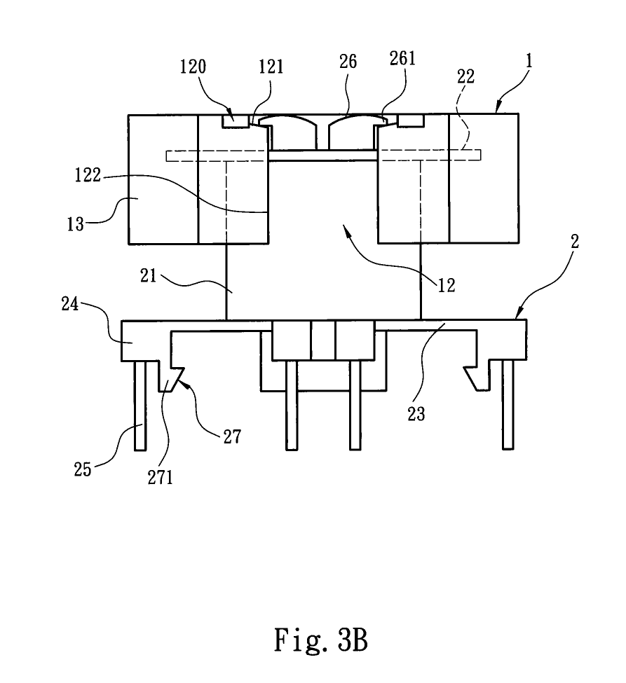

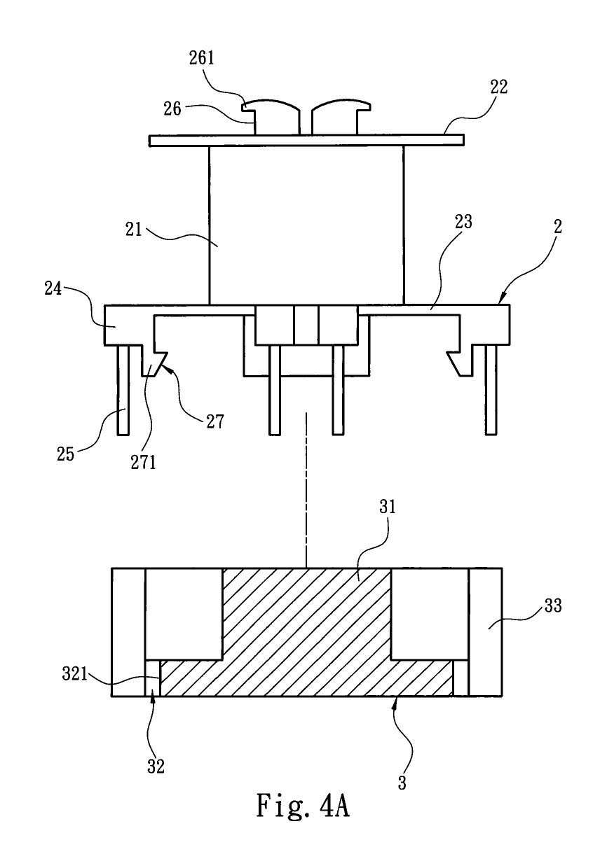

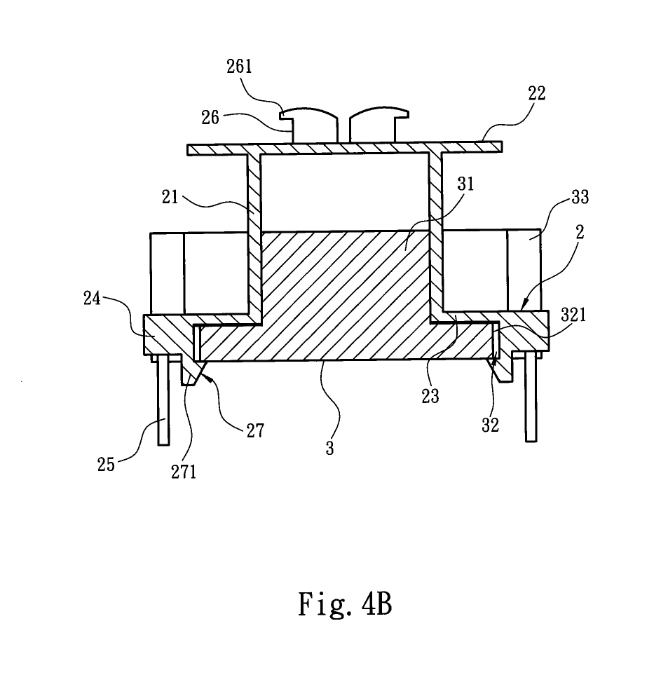

Referring to FIGS. 1, 2, 3A and 3B, two latch portions 26 are formed respectively at two corresponding sides of the first partition board 22. The two latch portions 26 at each side of the first partition board 22 are spaced from each other in a corresponding manner. Each latch portion 26 is flexible and extended upwards to correspond to the latch notch 12 of the first iron core 1 (referring to FIG. 3A). Each latch portion 26 also has at least one flexible hook 261. The hooks 261 of the two latch portions 26 are extended sideward to the left and right. When the first iron core 1 and the winding rack 2 are coupled, the hook 261 butts an inner edge 122 of the latch notch 12 so that the latch portion 26 is passed through the latch notch 12 through the retraction of the hook 261. The latch notch 12 has a retraction notch 120 formed at a distal end of the passing direction of the latch portion 26 so that the hook 261 can enter the retraction notch 120 to confine the first iron core 1 from escaping the winding rack 2 (referring to FIG. 3B). The retraction notch 120 may also have a lead angle 121 to guide the hook 261. Thus the latch portion 26 of the first partition board 22 can latch the first iron core 1 to form coupling between the first iron core 1 and winding rack 2. Refer to FIGS. 2, 4A and 4B for coupling of the winding rack 2 and second iron core 3. The second partition board 23 has a plurality of latch portions 27 to form another type of latching. As shown in FIGS. 2, 4A and 4B, each latch portion 27 is extended towards the second iron core 3, and also has a flexible hook 271 with a distal end extended inwards. When the second iron core 3 and winding rack 2 are coupled, the hook 271 butts an inner edge 321 of the latch notch 32 so that the latch portion 27 is passed through the latch notch 32 through the retraction of the hook 271; then the hook 271 latches on the surface of the second iron core 3 to confine the second iron core 3 from escaping.

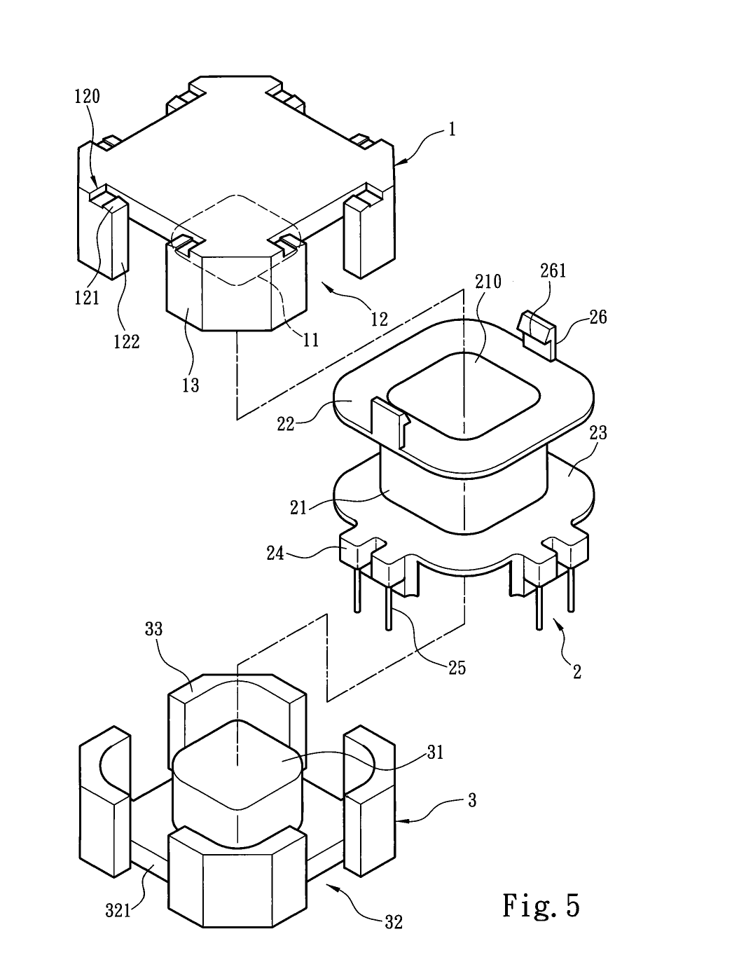

In the embodiment shown in FIGS. 1 through 4B, the latch portions 26 and 27 on the first partition board 22 and second partition board 23 are formed in different types. It is not to limit the latch portions 26 and 27 used on the upper or lower location, the latch portions 26 and 27 also are interchangeable. FIG. 5 illustrates another embodiment with the first and second iron cores 1 and 3 formed in the same types. The winding rack 2 also is substantially the same. However, the latch portion 26 on the first partition board 22 is changed with the distal end of the hook 261 facing inwards. The same as the latch portion 27 shown in FIGS. 1 through 4B. When the first iron core 1 and winding rack 2 are coupled as shown in FIG. 5, the hook 261 butts the inner edge 122 of the latch notch 12, the latch portion 26 is passed through the latch notch 12 through the retraction of the hook 261, and the hook 261 latches on the upper surface of the second iron core 3 to confine the first iron core 1 from escaping. In the embodiment shown in FIG. 5, the types of the latch portions 26 and 27, and hooks 261 and 271 are interchangeable. This is a technique known to those skilled in the art, hence various alterations of the latch portions 26 and 27 shall be included in the scope of the invention.

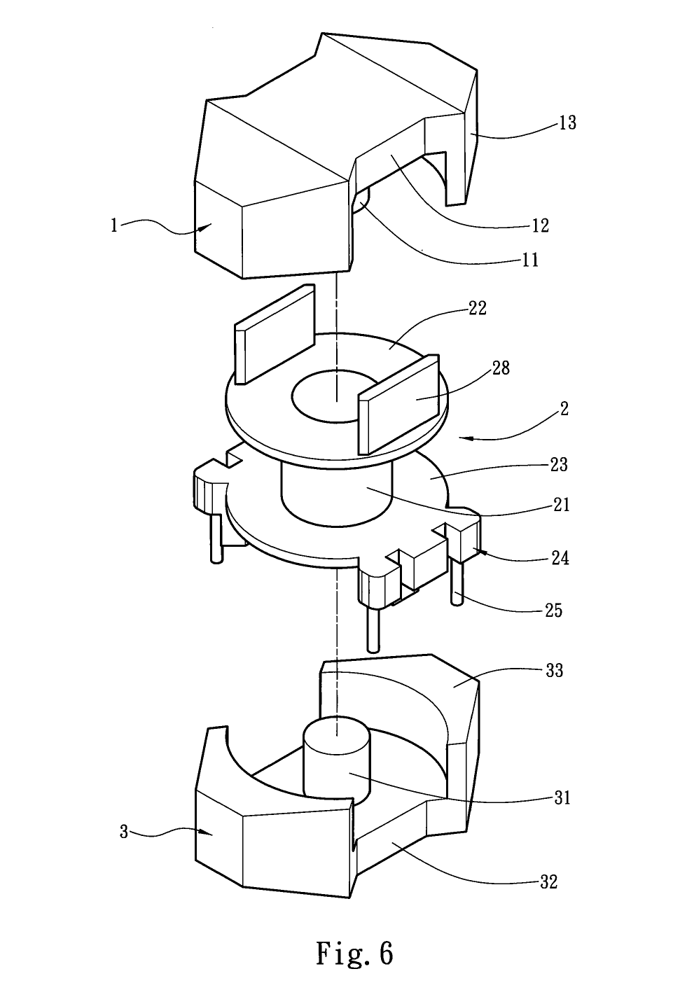

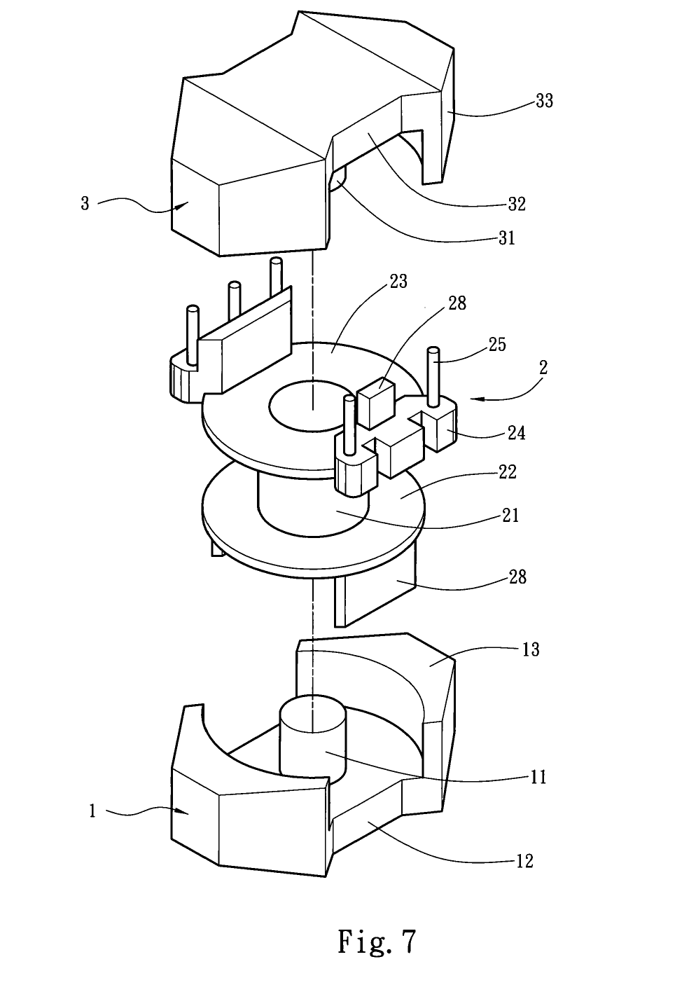

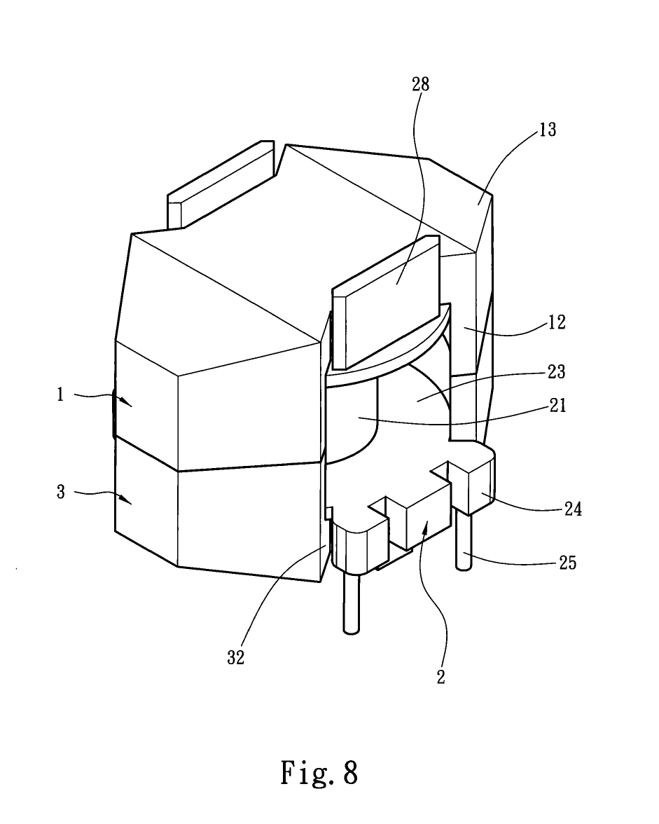

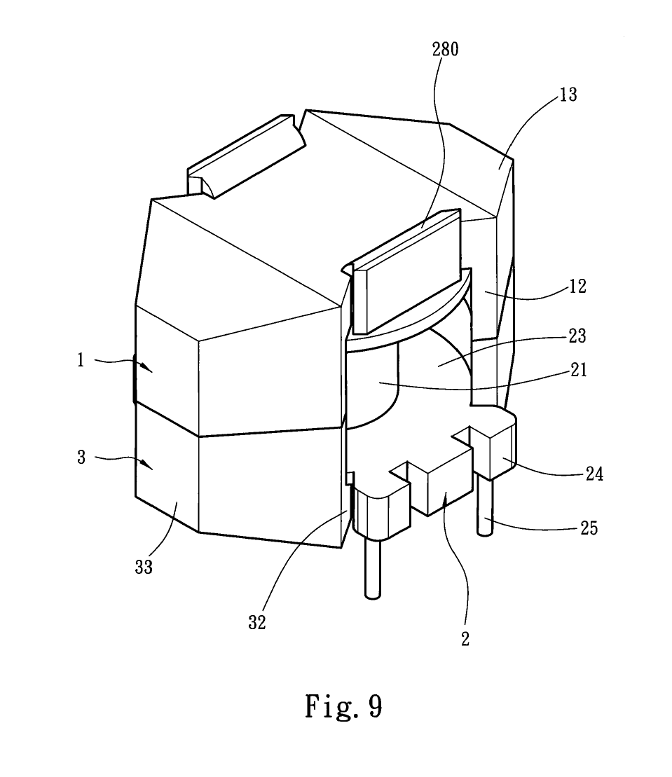

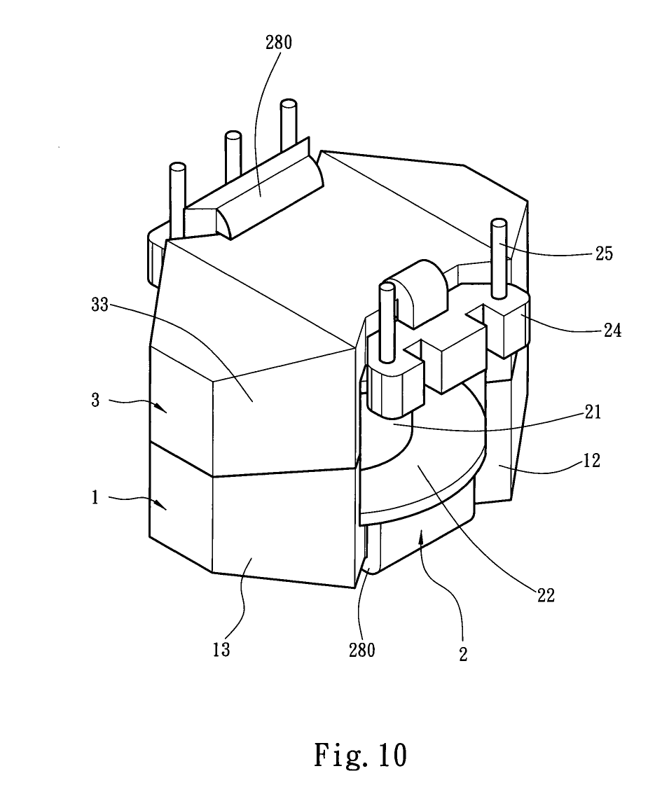

Refer to FIGS. 6 through 10 for yet another embodiment of the invention. The first iron core 1 and second iron core 3 shown in FIGS. 6 and 7 are formed in other types and have isolation walls 13 and 33 formed in polygon that are spaced by a plurality of latch notches 12 and 32. The first and second partition boards 22 and 23 have respectively at least one preset plastic material 28 located on the winding rack 2 where the latch notches 12 and 32 are desired to be exposed. The pin sections 24 also are located at positions where the latch notches 12 and 32 are desired to be exposed. When the first and second iron cores 1 and 3 are moved upwards and downwards to close to the winding rack 2, the pin sections 24 and plastic material 28 pass through the latch notches 12 and 32 and are exposed outside the first and second iron cores 1 and 3 (as shown in FIG. 8). Also referring to FIGS. 9 and 10, in order to couple the first and second iron cores 1 and 3 with the winding rack 2, the plastic material 28 on the first and second partition boards 22 and 23 is plastically formed to become a latch portion 280 latched with the latch notches 12 and 32 to hold the first and second iron cores 1 and 3 on the winding rack 2. The latch portion 280 is flexible and has a distal end formed at least one flexible hook to latch the first and second iron cores 1 and 3 on outer sides thereof to confine them from escaping.

With at least one latch portion 280 formed plastically on the first and second partition boards 22 and 23, the first and second iron cores 1 and 3 can be fastened to the winding rack 2 without using extra latch tools. The latch portion 280 is plastically formed after the first and second iron cores 1 and 3 and the winding rack 2 coupled with each other, thus the latch portion 280 can be closely in contact with the surfaces of the first and second iron cores 1 and 3. The plastic forming can be accomplished through existing techniques such as thermoplastic process, thermo-extrusion process and the like. Take thermo-extrusion process as an example, the formed plastic portion can be closely in contact with the surfaces of the first and second iron cores 1 and 3, hence the finished product of transformer does not loosen off due to dimensional errors formed during fabrication.

While the invention has been described by means of specific embodiments, numerous modifications and variations could be made thereto by those skilled in the art without departing from the scope and spirit of the invention set forth in the claims.

In summation of the above description, the present invention provides a significant improvement over the conventional techniques and complies with the patent application requirements, and is submitted for review and granting of the commensurate patent rights.

What is claimed is:

1. A tightly coupled iron core set and winding rack structure, comprising:
an iron core set including a core running through a bobbin and including a plurality of latch notches; and
a winding rack which includes the bobbin coupled on the core, a first partition board and a second partition board extended radially from two openings at two ends of the bobbin, and a plurality of pin sections located selectively on the first partition board, the second partition board, or both of the first partition board and the second partition board, the first partition board and the second partition board including respectively at least one latch portion latched with the latch notches to hold the iron core set.

2. The tightly coupled iron core set and winding rack structure of claim 1, wherein the iron core set further includes a plurality of isolation walls spaced from each other to form the latch notches.

3. The tightly coupled iron core set and winding rack structure of claim 1, wherein the iron core set includes a first iron core and a second iron core.

4. The tightly coupled iron core set and winding rack structure of claim 3, wherein the first iron core and the second iron core are respectively formed in a polygonal shape, the latch notches being located on edges of the first iron core and the second iron core.

5. The tightly coupled iron core set and winding rack structure of claim 1, wherein the latch portion is flexible and includes at least one flexible hook; the iron core set being coupled with the winding rack, and the hook butting an inner edge of the latch notch such that the latch portion passing through the latch notch through retraction of the hook, the latch notch including a retraction notch located at a distal end of the passing direction of the latch portion such that the hook wedging in the retraction notch to confine the iron core set from escaping.

6. The tightly coupled iron core set and winding rack structure of claim 2, wherein the latch portion is flexible and includes at least one flexible hook; the iron core set being coupled with the winding rack, and the hook butting an inner edge of the latch notch such that the latch portion passing through the latch notch through retraction of the hook, the hook latching on an outer surface of the iron core set to confine the iron core set from escaping.

7. The tightly coupled iron core set and winding rack structure of claim 2, wherein the pin sections include a plurality of conductive pins and are extended from the latch notches to outside of the isolation walls.

8. A tightly coupled iron core set and winding rack structure, comprising:
a winding rack which includes a hollow bobbin, a first partition board and a second partition board extended radially from two openings at two ends of the bobbin, and a plurality of pin sections located selectively on the first partition board, the second partition board, or both of the first partition board and the second partition board; and
an iron core set including a core running through the bobbin and including a plurality of latch notches;
wherein the first partition board and the second partition board include respectively at least one latch portion formed by plastic forming, the latch portions latching on the latch notches to hold the iron core set on the winding rack.

9. The tightly coupled iron core set and winding rack structure of claim 8, wherein the iron core set further includes a plurality of isolation walls spaced from each other to form the latch notches.

10. The tightly coupled iron core set and winding rack structure of claim 8, wherein the iron core set includes a first iron core and a second iron core.

11. The tightly coupled iron core set and winding rack structure of claim 10, wherein the first iron core and the second iron core are respectively formed in a polygonal shape, the latch notches being located on edges of the first iron core and the second iron core.

12. The tightly coupled iron core set and winding rack structure of claim 8, wherein the latch portion is flexible and includes at least one flexible hook which latches on an outer surface of the iron core set to confine the iron core set from escaping.

13. The tightly coupled iron core set and winding rack structure of claim 9, wherein the pin sections include a plurality of conductive pins and are extended from the latch notches to outside of the isolation walls.

14. The tightly coupled iron core set and winding rack structure of claim 8, wherein the plastic forming is selectively thermoplastic forming or thermo-extrusion forming.
